(19) United States
(12) Patent Application Publication
(10) Pub. No.: US 2014/0106718 A1
(43) Pub. Date: Apr. 17, 2014

(54) Tap-Once Method for care of mobile devices, applications and wireless services

(71) Applicants: Chenhui Liu, Wayland, MA (US); Frederick Mikkelsen, West Boylston, MA (US); Alberto Gutierrez, JR., Mountain View, CA (US)

(72) Inventors: Chenhui Liu, Wayland, MA (US); Frederick Mikkelsen, West Boylston, MA (US); Alberto Gutierrez, JR., Mountain View, CA (US)

(73) Assignee: CARRIER IQ, INC., Mountain View, CA (US)

(21) Appl. No.: 13/653,313

(22) Filed: Oct. 16, 2012

(51) Int. Cl. H04W 4/00

(52) U.S. Cl. 455/414.1

(57) ABSTRACT

A system communicatively couples a server to a plurality of mobile wireless device clients to receive and track customer care related information which has been captured on any one of the clients. The server uses information sent by a client to initiate a customer care request ticket and responds to the client request with a ticket number and request description compiled using the information from the client.

### RELATED APPLICATIONS

None.

### BACKGROUND

Currently, the following steps are conventionally performed before a service ticket is created with a Mobile Cellular Service Provider (the carrier):
1. Mobile subscriber calls in about request
2. Subscriber waits on the line, often for 10 minutes
3. Subscriber Service Representative (CSR) verifies device identification
4. Subscriber describes the request
5. CSR captures the request description in to a service ticket
6. Once the service ticket is captured, the Service Provider can begin investigation.
   It often takes subscriber and CSR (two people) 30 minutes to complete creation of a service ticket. It can be appreciated that efficiency, accuracy, and customer service may be improved by eliminating manual and verbal steps, and extended periods on hold on the telephone.

### BRIEF DESCRIPTION OF DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIGS. 1A-1C illustrate Tap-once care requesting in one embodiment of the present invention;

FIG. 2 is a system component diagram illustrating an embodiment of the present invention;

FIG. 3 is a flow diagram of a routine that enables Tap-once care request processing for a user;

FIG. 4 is a flow diagram of a routine that enables Tap-once care request processing with cached analytics for a user;

FIG. 5 is a flow diagram of a routine that enables Tap-once care request processing with root-cause screening for a user;

FIGS. 6-7 illustrate the presentations for user input and resulting transformations.

### SUMMARY OF THE INVENTION

Mobile Cellular Service Providers (Providers) have interest in assuring the highest quality of experience of service and customer care. This innovation is to use a mobile application to initiate the service call process to reduce the amount of time to log and register a request with the Service.

Several options are possible for installation or launching the application, for example, from the APP store or from the settings screen. The Tap-once-care application displays the subscriber experience measurements or Key Performance Indicators (KPIs) on a screen that is understandable to the subscriber. The Tap-once care application allows the subscriber to choose when they interact with Service Provider to initiate care requests and display status to the subscriber via the Tap-once-care screen.

### DETAILED DISCLOSURE OF EMBODIMENTS

A method and system for capturing and processing customer care request related to mobile device and/or wireless network service via mobile device and the Internet. The request is placed by a subscriber at a client system and received by a server system. The server system receives customer care related information that has been captured on the client. The server system then uses the information sent by the client to initiate a customer care request ticket and automatically respond to the client with ticket number and request description compiled using the information from the client. The care ticket summary will be sent to the mobile device with a link to an online care system for client to get details as needed.

With the Tap-once-Care Application:
1. User brings up application
2. Application presents and receives User selection of a check box of the nature of the request, e.g. “dropped call”, “poor coverage”, “slow download”, “battery problem”, “application crashes”, “phone screen freezes”, “other”.
3. User can optionally choose to have CSR call back later or call back now option before presses the service request button.
4. Upon user selection:
   a. Application retrieves device information.
   b. Application retrieves geographic location.
   c. Application captures the user's description of the request.
   d. Application communicates to Service Provider and creates Service Ticket on server side.
   e. Returns Service Ticket ID to the user for future reference.
5. The service provider can begin investigation.

When the subscriber submits a request description through Tap-once-Care, the carrier can immediately correlate the subscriber with a set of known issues captured up-to-date.

### With Cached Analytics Delivery in Tap-once Care

1. Subscriber brings up application
2. Application presents and receives user selection of a check box of the nature of the request, e.g. “dropped call”, “poor coverage”, “slow download”, “battery problem”, “application crashes”, “phone screen freezes”, “other”.
3. Upon user selection,
   a. Application retrieves device information.
   b. Application retrieves geographic location
   c. Application captures the user's description of the request and uploads corresponding cached analytics.
   d. Application communicates to Service Provider and creates Service Ticket on server side.
   e. Returns Service Ticket ID to the subscriber for future reference as well as the probable cause of the request that has been derived from the cached analytics.
   f. User has the option to accept the diagnosis, or have Service Provider continue the investigation.
4. The service provider can close the service ticket immediately if the user agrees, or begin investigation.
   a. As necessary, the Internal Service System may trigger subsequent upload requests for additional cached analytics.

With Root-Cause Screening, the Tap-once Care process becomes:
Subscriber brings up application,
Application presents and reads Subscriber selection of a check box of the nature of the request, e.g. “dropped call”, “poor coverage”, “slow download”, “battery problem”, “application crashes”, “phone screen freezes”, “other”.
Upon user selection,
Application retrieves device information.
Application retrieves geographic location if it has been captured on the mobile device.
Application captures the user's description of the request.
Application communicates to Service Provider and creates Service Ticket.
The service provider correlates users complaint with experience for users in that geographic area based on captured network analytics, and provides an immediate probable cause.
Returns Service Ticket ID to the subscriber for future reference as well as the probable cause of the request identified.
User has the option to accept that diagnosis, or continue the ticket. The service provider can close the service ticket immediately if the subscriber agrees.

With Localized Feedback on Service:
User brings up application
Application presents and receives User selection of a check box of the nature of the request, e.g. “dropped call”, “poor coverage”, “slow download”, “battery problem”, “application crashes”, “phone screen freezes”, “other”.
Upon user selection:
Application retrieves device information.
Application retrieves geographic location if it has been captured on the mobile device.
Application captures the user's description of the request.
If it is a common service request, the Service System returns a chart and information to describe how other users are fairing in that area, and asks the subscriber if this is sufficient.
Subscriber can chose to identify “not sufficient”, and the system can create a Service Ticket. The service provider can begin investigation.

Reference will now be made to the drawings to describe various aspects of exemplary embodiments of the invention. It should be understood that the drawings are diagrammatic and schematic representations of such exemplary embodiments and, accordingly, are not limiting of the scope of the present invention, nor are the drawings necessarily drawn to scale.

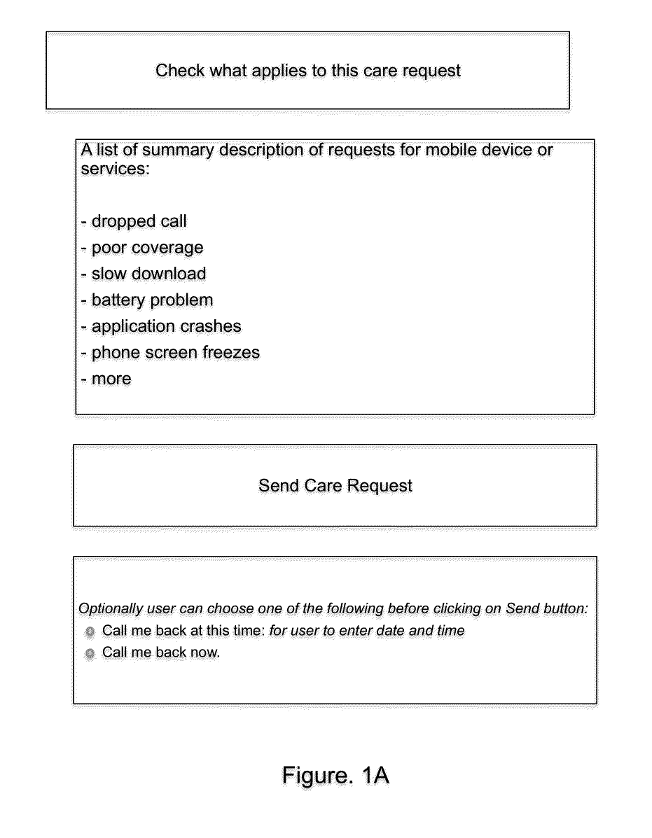

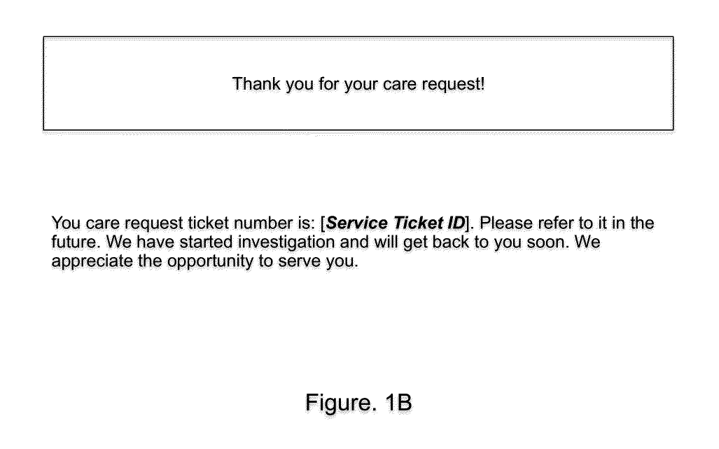

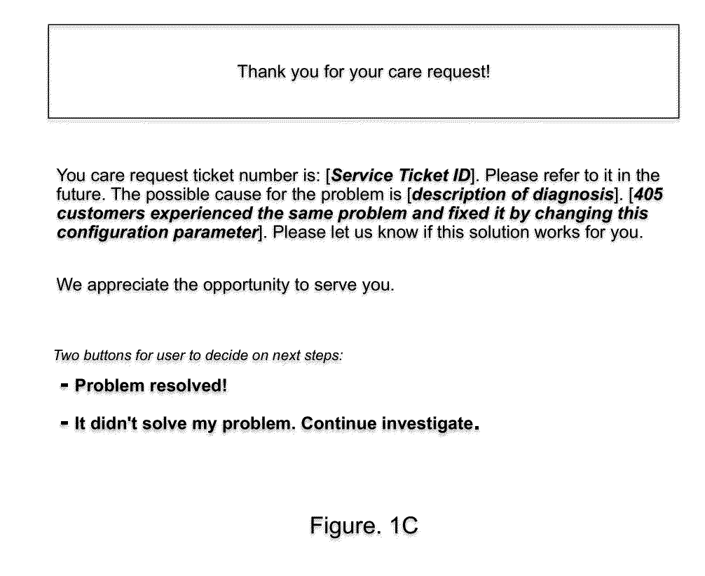

FIG. 1A is provided for expository but non-limiting purposes to convey the scope but not the limitation of the invention. The user may optionally select the urgency of receiving customer support. The user may select from a list of common complaints for efficiency and economy. The user may simply send the care request by tapping once.

FIGS. 1B and 1C are non-limiting exemplary displays which suggest two of the responses that a user may receive upon transmitting a service request. In the case of FIG. 1C the user may operate on buttons to direct next steps.

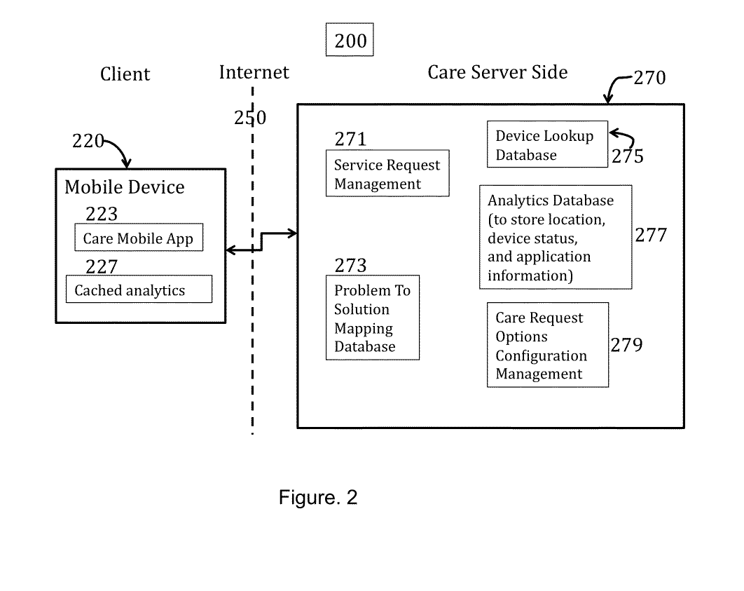

FIG. 2 illustrates system components in one embodiment of the present invention. The component of “Care Request Options Configuration Management” 279 in FIG. 2 is for configuring the list of care request options for user to choose from. The list can be configured based on mobile device make, model, firmware version, problems having been observed up-to-date etc.

The component of “Service Request Management” 271 in FIG. 2 manages life cycle of a service ticket from creation to close. It automatically creates a service ticket after receiving a service request from the client. It also communicates back to the client with the service ticket ID, probable causes and resolution.

The component of “Problem To Solution Mapping Database” 273 in FIG. 2 stores solutions mapped to solve corresponding problems. It can be used to generate resolution in automated response to a service request. The care server side 270 further comprises a device lookup database 275 stored in computer readable non-transitory storage and an analytics database 277 stored in computer readable non-transitory storage which stores location, device status, and application information. Within the Mobile Device 220, are cached analytics 227 in non-transitory computer readable media, and a care mobile app 223 which is enabled to capture the service request and read the cached analytics upon user initiation and to transmit the service request and cached analytics through the wireless media and internet 250 to the Care server side 270.

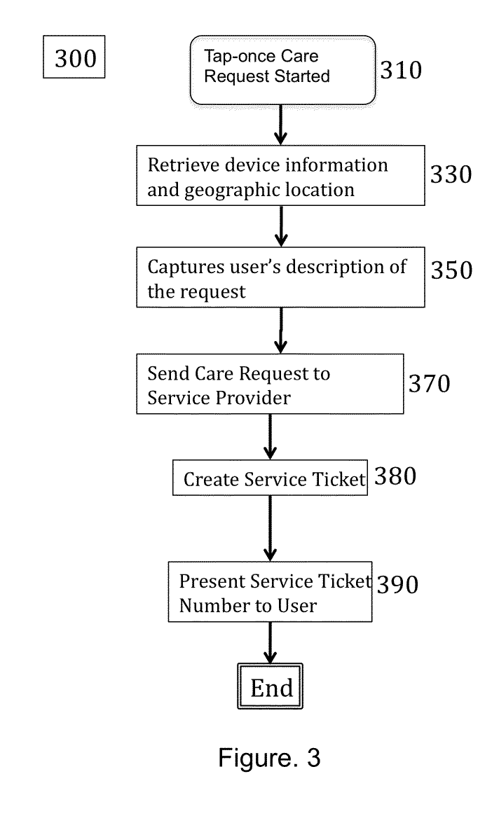

FIG. 3 is a flowchart of a method. Step 310 initiates the process of tap-once care request: retrieving device information and geographic location 330; capturing user's description of the request 350; sending care request to the service provider 370; creating a service ticket 380; and presenting the service ticket number to the user 390.

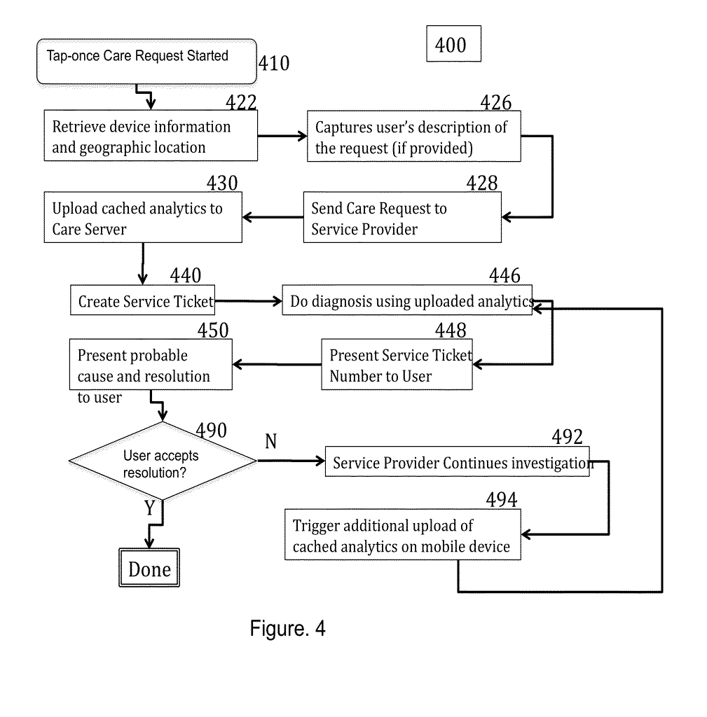

FIG. 4 is a flowchart of a method. Step 410 initiates the process of the method: retrieving device information and geographic location 422; if the user provides description of the problem (for example as in FIG. 1A then capture user's description of the request 426; sending the care request to the service provider (“tap-once”) 428; uploading cached analytics to care server 430; creating a service ticket 440; doing a diagnosis using uploaded analytics 446; presenting a service ticket number to the user 448; presenting a probable cause and resolution 450; upon user accepting resolution 490, Done 498; and upon user not accepting resolution, continuing investigation by the service provider 492 and triggering additional upload of cached analytics on mobile device 494.

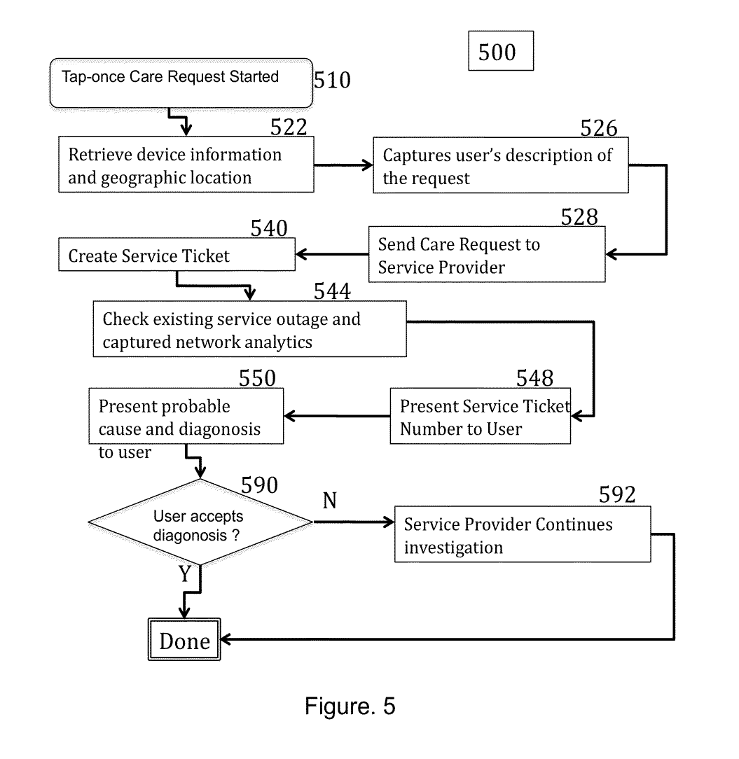

FIG. 5 is a flowchart of a method. Step 510 initiates the process of the method: retrieving device information and geographic location 522; capturing user's description of the request 526; sending the care request to the service provider 528; creating a service ticket 540; checking existing service outages and captured network analytics 544; presenting a service ticket number to the user 548; presenting a probable cause and diagnosis 550; upon user accepting diagnosis 590, Done; and upon user not accepting diagnosis, continuing investigation by the service provider 592.

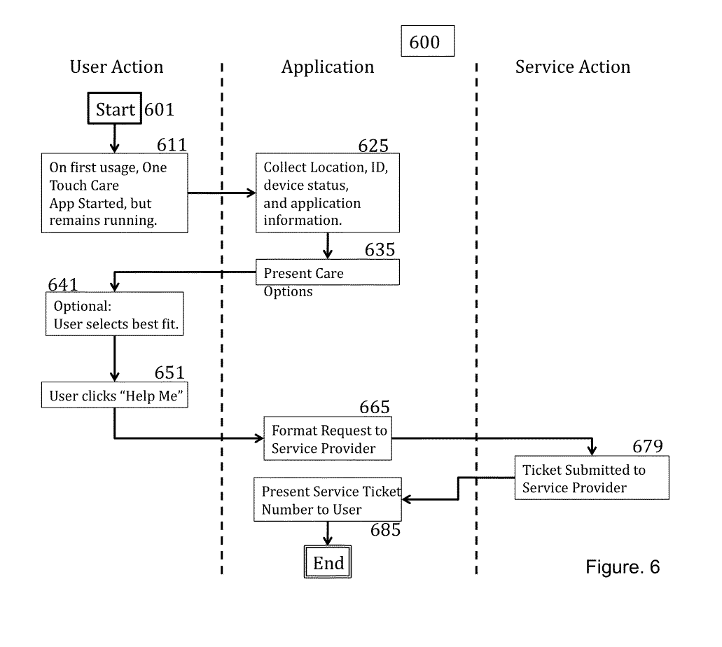

FIG. 6 illustrates a typical usage model of the invention: Step 601 initiates the method by user action; one touch care app starts and remains running 611; the application collects location, ID, device status, and application information 625; the application presents care options to the user 635; the user selects the best fit of the options presented on a display 641; the user clicks “help me” on the user interface 651; the application formats and transmits a request to the service provider 665; the server side submits a ticket to the service provider and obtains a number 679; and the application receives and presents the service ticket number to the user 685.

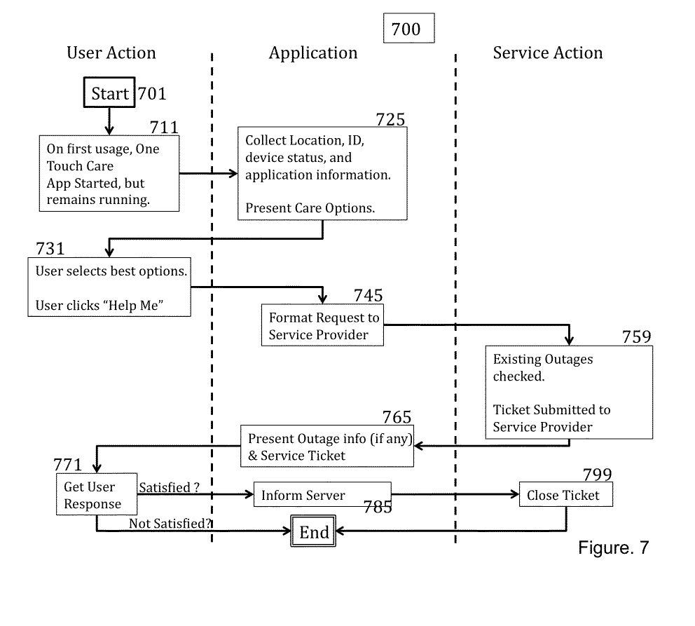

FIG. 7 illustrates an other usage model of the invention: Step 701 initiates the method by user action; one touch care app starts and remains running 711; the application collects location, ID, device status, and application information and presents Care Options to the user 725; the user selects best options and clicks “help me” on the user interface 731; the application formats and transmits a request to the service provider 745; the server side checks existing outages and submits a ticket to the service provider and obtains a service ticket number 759; the application receives and presents outage information and the service ticket number to the user 765; the user may select one of satisfied or not satisfied as a user response 771; on the condition that the user is satisfied, the application informs the server 785; and the server closes the ticket 799.

### Conclusion

The present invention is easily distinguished from conventional operator intensive support of mobile users which cannot scale with the growth in number of users. This innovation is to use the Tap-once-Care to automate the process of submitting quality of service issues from the subscriber to customer care alleviating the subscriber from tedious interaction and saving the subscribers time. The innovation automates and streamlines the user's problem description and acts as the trigger to upload the cached analytics to the service provider and provide clues to what other information to bring in for correlation to facilitate the diagnosis of the request. The innovation automates the collection of diagnostic information (i.e., cached analytics) and removes the subscriber from interactions that can be automated and the subscriber's interaction is only needed to approve of the results rather than collect information. This process saves time and effort on the subscriber and customer care representative.

This Tap-once-Care system is novel because the subscriber's service request is automated with an Application that streamlines the service request, including identification of the problem and attaching cached analytics that provide key diagnostics for determining the root cause of the problem and corrective action. Furthermore, the automated and streamlined ticket creation and submission standardizes the service ticket and diagnostic information and this Subscribers service request may subsequently be correlated with similar localized service requests in order to determine the root cause and corrective action. The Tap-once-Care system automates the collection of diagnostic information (i.e., cached analytics) and removes the subscriber from interactions that can be automated. The subscriber's interaction is only needed to approve of the results rather than collect information. This process saves time and effort on the subscriber and customer care representative by improving efficiency, accuracy. Customer service is improved by eliminating manual and verbal steps.

In embodiments, the invention comprises a method for supporting users of wireless device with a Tap-once-care service comprising: under control of a client system,

displaying user selectable service request choices on a mobile device; and

in response to a single user action, sending a request to initiate customer care process along with mobile device identifiers (in an embodiment, directory number, device ID, power-on time, battery charge), care request choices and device configuration information to a care server system;

under control of a single-action care component of the server system,

receiving the request;

retrieving additional information previously stored for the subscriber identified by the identifier in the received request; and

generating a care ticket to contain the request related data obtained from the client for the customer; and notifying subscriber that the reported request being captured and worked on;

whereby the customer care request is captured with detailed and accurate information to describe the request without using a traditional customer-call-CSR model (i.e. a subscriber calling Customer Service Representative via phone to describe a request encountered on a mobile device).

In an embodiment the displaying of information includes displaying information indicating the single action. In an embodiment the single action is clicking a button. In an embodiment, a subscriber does not need to explicitly identify him or her self when sending a customer care request.

An other aspect of the invention is embodied in a client apparatus for requesting customer care which uses circuits, processors, and software to provide:

an identifier (in an embodiment one of a directory number or an IMEI) that identifies a customer;

a display component for displaying service quality or device performance;

a single-action care-requesting component that in response to performance of only a single action, sends a request to a care server system to report the request and requesting for customer care, the request including the identifier so that the server system can locate additional information needed to capture the request accurately and so that the care server system can generate a care ticket with detailed request description based on data obtained from the client system. In an embodiment, display component is a mobile application that has access to a software API to obtain service quality and device performance data. In an embodiment, the predefined action is operating on a user interface of a mobile device.

An other aspect of the invention is a server for generation of a care ticket and start care process comprising:

a customer care ticketing component; and

a single-action care component comprising:
a data storage medium storing information for a plurality of users;
a receiving component for receiving a request to open a care ticket, the request comprising an indication of one of the plurality of users; and
a component that retrieves from the data storage medium information for the indicated subscriber and that uses the retrieved information to open a care ticket for the indicated subscriber for the reported request. In an embodiment, the server also includes: an automatic care component that finds best matching solution in accordance with the request captured by the care component; and a notification system to send the best matching solution to the client. In an embodiment, the request is sent by a client in response to a single user action being performed.

An other aspect of the invention is a mobile wireless client device apparatus enabled for Tap-once care, which includes: a baseband processor radio circuit, an application processor circuit, a display and subscriber input device, a circuit to retrieve device information, a circuit to retrieve geographic information, a circuit to display selectable requests, a circuit to capture a user selection of a selected request, and initiate a request transmission to a centralized customer care server, and a processor and memory coupled to all the above. In an embodiment, the client apparatus also has a circuit to cache analytics in an embodiment, device diagnostics and device performance data.

An other aspect of the invention is a computer-implemented method for operation of a mobile wireless client device: displaying a selectable array of service requests; receiving a user selection of a service request; retrieving device information; retrieving geographic information; transmitting device information and geographic information to a centralized customer service server with the selected service request; receiving a service ticket number associated with the service request from the centralized customer service server: and displaying a service ticket number, an associated service ticket status, and a service ticket resolution. In an embodiment, the method further comprises: receiving information on service ticket requests from other users in the same geographic area; and receiving a user selection to select as ticket resolution from one of discard the service ticket number and retain the service ticket number.

An other aspect of the invention is a method for operation of a centralized customer care server communicatively coupled to a plurality of mobile wireless client devices, the method comprising: receiving from a transmitting mobile wireless client device a request type; receiving from the transmitting mobile wireless client device location id, device status, and application information coincident with the request type;

storing in non-transitory media a computer readable record of the request type, the device status, and the application information as a service request, generating a service ticket number and service request report; transmitting the service ticket number and service request report to a service provider host system; and transmitting the service ticket number to the transmitting mobile wireless client device.

In an embodiment the method also includes: determining an immediate probable cause candidate by correlating a first service request with at least one other user in a location id which is substantially in the same geographical area and having substantially similar device status and application information and a previously determined probable cause; transmitting the immediate probable cause to the mobile wireless client device; and receiving a user selection to continue the service ticket or discard the service ticket.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

A number of embodiments of the invention have been described. Nevertheless, it will be understood that various modifications may be made without departing from the spirit and scope of the invention. For example, other network topologies may be used. Accordingly, other embodiments are within the scope of the following claims.

We claim:

1. A method for supporting users of wireless device with a Tap-once-care service comprising:
under control of a client system,
displaying user selectable service request choices on a mobile device; and
in response to a single user action, sending to a care server system a request to initiate customer care process along with at least one of a directory number, device ID, care request choices, cached-analytics (comprising cache device diagnostics and device performance data) and device configuration information;
under control of a single-action care component of the server system,
receiving the request;
retrieving additional information previously stored for the subscriber identified by the identifier in the received request; and
generating a care ticket to contain the request related data obtained from the client for the customer;
and notifying subscriber that the reported request being captured and worked on;
whereby the customer care request is captured with detailed and accurate information to describe the request without a subscriber speaking to Customer Service Representative via phone to describe a request encountered on a mobile device.

2. The method of claim 1 wherein the displaying of information includes displaying information indicating the single action.

3. The method of claim 1 wherein the single action is clicking a button.

4. The method of claim 1 wherein a subscriber does not need to explicitly identify himself or herself when sending a customer care request.

5. A client apparatus for requesting customer care comprising:
a computer readable store which contains one of a directory number and an IMEI that identifies a customer;
a display component for displaying service quality or device performance;
a single-action care-requesting component that in response to performance of only a single action, sends a request to a care server system to report the request and requesting for customer care, the request including the identifier so that the server system can locate additional information needed to capture the request accurately and so that the care server system can generate a care ticket with detailed request description based on data obtained from the client system.

6. The client apparatus of claim 5 wherein the display component is a mobile application that has access to a software API to obtain service quality and device performance data.

7. The client of claim 5 wherein the predefined action is operating on a user interface of a mobile device.

8. A server for generation of a care ticket and start care process comprising:
a customer care ticketing component; and
a single-action care component comprising:
a data storage medium storing information for a plurality of users;
a receiving component for receiving a request to open a care ticket, the request comprising an indication of one of the plurality of users; and
a component that retrieves from the data storage medium information for the indicated subscriber and that uses the retrieved information to open a care ticket for the indicated subscriber for the reported request.

9. The server of claim 8 further comprising:
an automatic care component that finds best matching solution in accordance with the request captured by the care component; and
a notification system to send the best matching solution to the client.

10. The care server system of claim 8 wherein the request is sent by a client in response to a single user action being performed.

11. A mobile wireless client device apparatus enabled for Tap-once care, the apparatus comprising:
a baseband processor radio circuit,
an application processor circuit,
a display and subscriber input device,
a circuit to retrieve device information,
a circuit to retrieve geographic information,
a circuit to display selectable requests,
a circuit to capture a user selection of a selected request, and initiate a request transmission to a centralized customer care server,
and
a processor and memory coupled to all the above.

12. The apparatus of claim 11 further comprising:
a circuit to cache device diagnostics and device performance data.

13. A method for operation of a mobile wireless client device, the method comprises:
displaying a selectable array of service requests;
receiving a user selection of a service request;
retrieving device information;
retrieving geographic information;
transmitting device information and geographic information to a centralized customer service server with the selected service request; and
receiving a service ticket number associated with the service request from the centralized customer service server: and
displaying a service ticket number, an associated service ticket status, and a service ticket resolution.

14. The method of claim 13 further comprises:
receiving information on service ticket requests from other users in the same geographic area; and
receiving a user selection to select as ticket resolution from one of discard the service ticket number and retain the service ticket number.

15. A method for operation of a centralized customer care server communicatively coupled to a plurality of mobile wireless client devices, the method comprising:
receiving from a transmitting mobile wireless client device a request type;
receiving from the transmitting mobile wireless client device location id, device status, and application information coincident with the request type;
storing in non-transitory media a computer readable record of the request type, the device status, and the application information as a service request,
generating a service ticket number and service request report;
transmitting the service ticket number and service request report to a service provider host system; and
transmitting the service ticket number to the transmitting mobile wireless client device.

16. The method of claim 15 further comprising:
determining an immediate probable cause candidate by correlating a first service request with at least one other user in a location id which is substantially in the same geographical area and having substantially similar device status and application information and a previously determined probable cause;
transmitting the immediate probable cause to the mobile wireless client device; and
receiving a user selection to continue the service ticket or discard the service ticket.
